(19) United States
(12) Patent Application Publication
(10) Pub. No.: US 2017/0188164 A1
(43) Pub. Date: Jun. 29, 2017

(54) HEARING DEVICE

(71) Applicant: SIVANTOS PTE. LTD., Singapore (SG)

(72) Inventor: AREND KLOSTERMEIER, KIRCHLENGERN (DE)

(21) Appl. No.: 15/391,981

(22) Filed: Dec. 28, 2016

(30) Foreign Application Priority Data
Dec. 29, 2015 (DE) 10 2015 226 813.6

(51) Int. Cl. H04R 25/00

(52) U.S. Cl. CPC H04R 25/656; H04R 2460/17; H04R 2225/025

(57) ABSTRACT

A hearing device has a housing with a housing main body and a finger-shaped extension for receiving an ear mold. The finger-shaped extension, starting from a housing base, extends along an insertion direction of the hearing device. A length of the finger-shaped extension along the insertion direction is at least 50% of the corresponding total length of the housing in the insertion direction. A width of the housing base transverse to the insertion direction is at most 40% of the corresponding maximum width of the housing in the transverse direction.

### CROSS-REFERENCE TO RELATED APPLICATION

This application claims the priority, under 35 U.S.C. §119, of German patent application DE 10 2015 226 813.6, filed Dec. 29, 2016; the prior application is herewith incorporated by reference in its entirety.

### BACKGROUND OF THE INVENTION

### Field of the Invention

A hearing device serves to supply a hearing-impaired person with acoustic signals from the surroundings, the acoustic signals being suitably processed, in order to compensate the specific hearing impairment, and in particular amplified. To this end, a hearing device usually comprises an acousto-electric input transducer, commonly in the form of a microphone, a signal processing unit with an amplifier, and an electro-acoustic output transducer. The output transducer is generally realized as a miniaturized loudspeaker and is also referred to as a receiver. It generates the acoustic output signals for the person wearing the hearing device.

Different designs of hearing devices are offered in order to meet the great many individual requirements. In the case of BTE (behind-the-ear) hearing devices, a housing that contains components such as a battery and the signal processing unit is worn behind the ear. A flexible sound tube guides the acoustic output signals of the receiver from the housing to the auditory canal. In the case of so-called ITE (in-the-ear) hearing devices, a housing that contains all the functional components, including the microphone and the receiver, is worn at least partly in the auditory canal. CIC (completely-in-canal) hearing devices are similar to the ITE hearing devices, but are worn completely in the auditory canal.

Irrespective of the design of the particular hearing device, they are often used in combination with ear molds. Ear molds are the direct connection between the hearing device and the ear. They are either attached to the sound tube of behind-the-ear (BTE) hearing devices or fixedly connected to the housing of in-the-ear (ITE) hearing devices and fitted directly into the ear. Ear molds ensure a secure hold of the hearing devices within the auditory canal and/or the pinna and can additionally promote the amplifying effect by the hearing device.

Ear molds are produced as tailor-made items specifically for the individual wearing the hearing device. An ear impression is taken which is left to set in the ear. On the basis of the ear impression, an individual ear mold can be produced for the specific person wearing the hearing device.

However, ear molds cannot be combined readily with all hearing devices. Difficulties arise, for example, in in-the-ear hearing systems with standard shells or standard housings (instant-fit ITE hearing systems). Such instant-fit ITE hearing systems are designed so that they can be used as universally as possible. In a first design, the contour of the shell or of the housing more or less follows the auditory canal. In an alternative second design, the contour does not follow the auditory canal to provide a general fit; the housing or the shell tapers only in the area of the receiver. Instant-fit hearing devices are usually used with attached small elastic caps, referred to as domes, in order to obtain a sufficient hold in the auditory canal. On the housing of the first variant, it is in most cases not possible to receive an individual ear mold to improve wearing comfort, on account of the fact that the housing contour already follows the auditory canal. In the second variant, the fit of the hearing device is also not optimal when an ear mold is attached.

### SUMMARY OF THE INVENTION

It is accordingly an object of the invention to provide a hearing device which overcomes the above-mentioned and other disadvantages of the heretofore-known devices and methods of this general type and provides for a hearing device which can be used universally and improves the wearing comfort.

With the foregoing and other objects in view there is provided, in accordance with the invention, a hearing device, comprising:

a housing having a housing main body and a finger-shaped extension for receiving an ear mold;

the housing having a total length in an insertion direction of the hearing device and a maximum width transverse to the insertion direction;

the finger-shaped extension, starting from a housing base, extending along the insertion direction of the hearing device;

the finger-shaped extension having a length along the insertion direction amounting to at least 50% of the total length of the housing;

the housing base having a width transverse to the insertion direction amounting to at most 40% of the maximum width of the housing; and

the finger-shaped extension having external dimensions along the length smaller than or equal to the width of the housing base.

In other words, the objects of the invention are achieved, by a hearing device with a housing, the housing comprising a housing main body, and a finger-shaped extension for receiving an ear mold, wherein the finger-shaped extension, starting from a housing base, extends along an insertion direction of the hearing device, wherein the length of the finger-shaped extension along the insertion direction is at least 50% of the corresponding total length of the housing in this direction, wherein the width of the housing base transverse to the insertion direction is at most 40% of the corresponding maximum width of the housing in this direction, and wherein the external dimensions of the extension along its length are smaller than or equal to the width of the housing base. In other words, starting from the housing base, the finger-shaped extension extends in the insertion direction with a width or a diameter of at most 40% of the total width of the housing. The diameter of the extension up to the tip remains the same as the width of the housing base or preferably tapers along the insertion direction. To put it another way, the maximum permissible width of the housing base is at the same time the maximum permissible external dimension of the extension.

In a first step, the invention proceeds from the fact that, depending on the anatomy of the auditory canal or inner ear of a person wearing the hearing device, the amount of space available for the positioning of a hearing device varies. This may be disadvantageous particularly in persons with small or narrow auditory canals. For example, if little space is available on account of the anatomy, it is not possible for an instant-fit hearing system of the first design variant as described above to be provided with an individual ear mold placed on the housing. A sufficient wall thickness of the ear mold cannot be ensured here. In other words, the anatomy of the ear or of the auditory canal of a person wearing the hearing device unfortunately determines the choice of the wearable and therefore usable hearing devices.

In a second step, the invention considers the notion that a modified geometry of the housing or of the contour of the hearing device could satisfy the anatomical circumstances. To this end, in a third step of the invention, the housing of the hearing device, in contrast to housings that have hitherto been customary, is produced with an area which follows the auditory canal but which provides increased available space in the auditory canal for receiving an ear mold. For this purpose, the housing of the hearing device has a finger-shaped extension which extends into the auditory canal and which receives an ear mold, the length of which in relation to the insertion direction of the hearing device is at least half the total length of the housing and at most 40% of the maximum width of the housing in this direction.

The finger-shaped extension is slender in diameter, compared to a known instant-fit device, as far as the housing base and represents the area of the housing receiving an ear mold. This receiving area is longer and more slender than the receiving areas of customary housings. With the stated features in general, a contour of the housing is obtained that follows the auditory canal and that tapers in the receiver-side area. In the area of the receiver, additional and sufficient space is created between the extension and the wall of the auditory canal in order to receive an individual ear mold. An ear mold can also be used in small or narrow auditory canals, since the ear molds can be produced with a sufficient wall thickness on account of the increased available space.

The insertion direction of the hearing device designates the direction in which the housing of the hearing device is inserted into the auditory canal of a person wearing the hearing device. In the inserted state, the finger-shaped extension extends into the auditory canal of the person wearing the hearing device. On account of its comparatively small dimensions as far as the housing base, of which the width is at most 40% of the housing width as a whole, ear molds for narrow auditory canals can be received. This was previously not possible, or it was possible only to a limited extent. The housing itself is expediently produced in one piece from a plastic material.

Particularly preferably, the total length of the housing including the finger-shaped extension lies in a range between 12 mm and 17 mm. The housing as such can therefore be used in principle in smaller or narrow auditory canals.

In order to ensure sufficient space for receiving an ear mold, particularly on the side of the housing protruding into an auditory canal in the state of use, the cross-sectional area of the finger-shaped extension perpendicular to the insertion direction tapers in the insertion direction, preferably starting from the housing base. Overall, the tapering has the effect that more space is obtained, which makes it easier to receive an ear mold and also to receive narrow ear molds.

It is also of advantage if the cross-sectional area of the housing main body perpendicular to the insertion direction tapers in the insertion direction, as far as the housing base. The cross-sectional area on the side of the housing directed outward in the state of use is therefore greater than the cross-sectional area at the housing base. Such a design improves the universal use of a hearing device with the corresponding housing.

In order to increase the wearing comfort and if appropriate to improve the amplification effect of the hearing device, an ear mold is expediently arranged on the finger-shaped extension.

The ear mold is preferably secured with force-fit engagement on the finger-shaped extension. A force-fit connection, which is also referred to as a friction fit or non-positive connection, is releasable; the strength of the force-fit connection is ensured by the normal force acting between the connected components. The releasability of the connection of the ear mold to the housing means that the ear mold can be removed if necessary. This may have to be done for repair or cleaning.

The ear mold, along the insertion direction, is preferably received with its entire length by the finger-shaped extension. Thus, the ear mold does not protrude beyond the finger-shaped extension in the insertion direction and is preferably connected, along its entire length, with force-fit engagement to the finger-shaped extension. By virtue of the ear mold being received completely by the finger-shaped extension, a secure fit of the ear mold is ensured, and therefore also a comfortable fit and comfortable feel for the person wearing the hearing device.

Moreover, the housing is expediently closed with a housing lid on the side directed away from the finger-shaped extension. The components of the hearing device that are arranged inside the housing are thus held secure. Moreover, the electronics in particular are protected from external influences. A recovery element, for example in the form of a plastic web or the like, is expediently mounted on the housing lid and allows the hearing device to be pulled out of the auditory canal. Moreover, the housing lid preferably accommodates operating elements such as switches, for adjusting the hearing device, or a battery compartment.

The housing preferably accommodates at least one microphone, a signal processing unit connected to the microphone or to each microphone, and a loudspeaker connected to the signal processing unit. By means of the one or more microphones, the surrounding sounds are captured and converted into an electrical signal. The electrical signal is amplified and further processed in the signal processing unit. The amplified electrical signal is converted back to an acoustic signal in the receiver and forwarded to the eardrum of the person wearing the hearing device.

The hearing device is preferably designed as an in-the-ear hearing device. The housing of the hearing device sits in the pinna and closes the external auditory canal. If the housing, or a housing lid closing the housing, is visible from the outside, it is expedient, for cosmetic reasons, to adapt the housing or the housing lid to the skin color.

Other features which are considered as characteristic for the invention are set forth in the appended claims.

Although the invention is illustrated and described herein as embodied in a hearing device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a schematic view of a housing of a hearing device according to the prior art with an attached dome;

FIG. 2 shows a schematic view of a housing with a finger-shaped extension for receiving an ear mold according to the invention; and

FIG. 3 shows a schematic view of the housing according to FIG. 2 with a received ear mold.

### DETAILED DESCRIPTION OF THE INVENTION

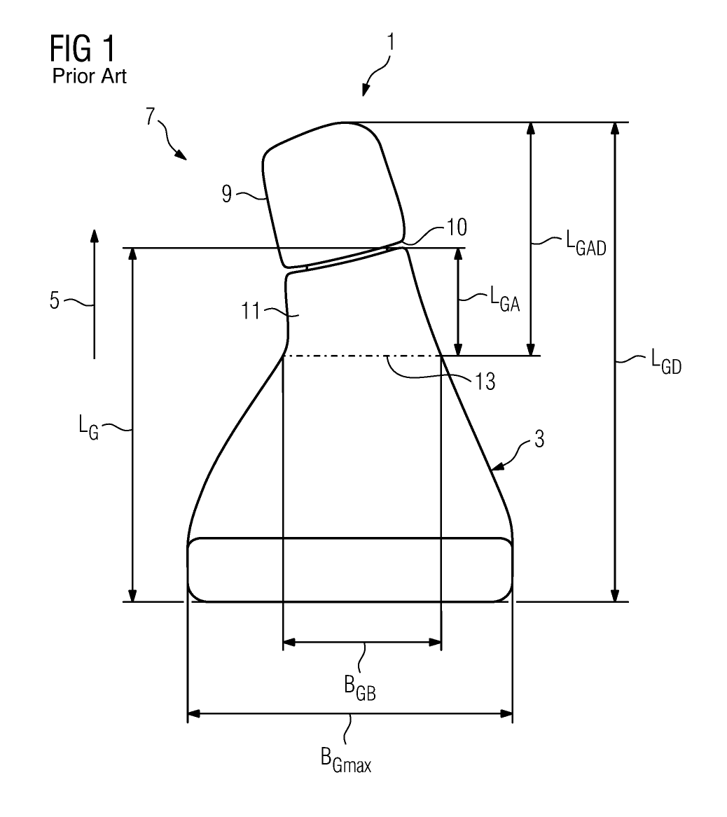

Referring now to the figures of the drawing in detail and first, particularly, to FIG. 1 thereof, there is shown a schematic view of an in-the-ear hearing device 1 from the prior art with a customary housing 3 (also called a shell). The housing 3 is made in one piece from a plastic. The outer contour of the housing 3, in the insertion direction 5, follows approximately the contour of an auditory canal and, on the side 7 protruding into the auditory canal in the state of use, is provided with a small cap, referred to as a dome 9, which is placed with a securing portion 10 on the housing 3.

The total length L_{G} of the housing 3 without the dome 9 is 13 mm, for example. With the dome 9 attached, the total length L_{GD} is 18 mm, for example. It will be seen that the contour of the housing 3 tapers in the insertion direction 5. However, the housing 3 does not have a finger-shaped extension extending along the insertion direction 5 of the hearing device 1. The hearing device 1 is held and worn with the dome 9 in the auditory canal.

To receive an ear mold, the housing 3 basically only has the housing portion 11 that extends above the dash-dot line 13. In the case of narrow ear molds of the kind required for persons with narrow and tight auditory canals, these cannot be secured on the housing portion 11. To do so, the ear molds would have to be produced with such a small wall thickness that the stability and secure fastening of the corresponding ear mold could not be ensured. There is not enough space available between the housing portion 11 and the wall of the auditory canal.

In relation to the line 13, the length L_{GAD} of the housing portion 11 extending along the insertion direction 5 away from the line 13, inclusive of the attached dome 9, is approximately 8 mm for example, which corresponds to about 44% of the corresponding total length L_{G} of the housing 3 in this direction.

Without the attached dome 9, the length L_{GA} of the housing portion 11 along the insertion direction 5 is only approximately 3.5 mm, which corresponds approximately to 27% of the corresponding total length L_{G} of the housing 3 in this direction.

The maximum width B_{Gmax} of the housing 3 is 12 mm, for example, transverse to the insertion direction 5. The width B_{GB} of the housing base, i.e. the width along the line 13 transverse to the insertion direction 5, is in this case 6 mm for example, which corresponds to approximately 50% of the corresponding maximum width B_{Gmax} of the housing 3 in this direction. The housing 3 overall is wider in the plane shown than it is in the plane perpendicular to this. The width B_{GB} of the housing base on the line 13 in the drawing plane is also wider than in the plane perpendicular thereto. This applies moreover for all the hearing devices shown in FIGS. 1 to 3.

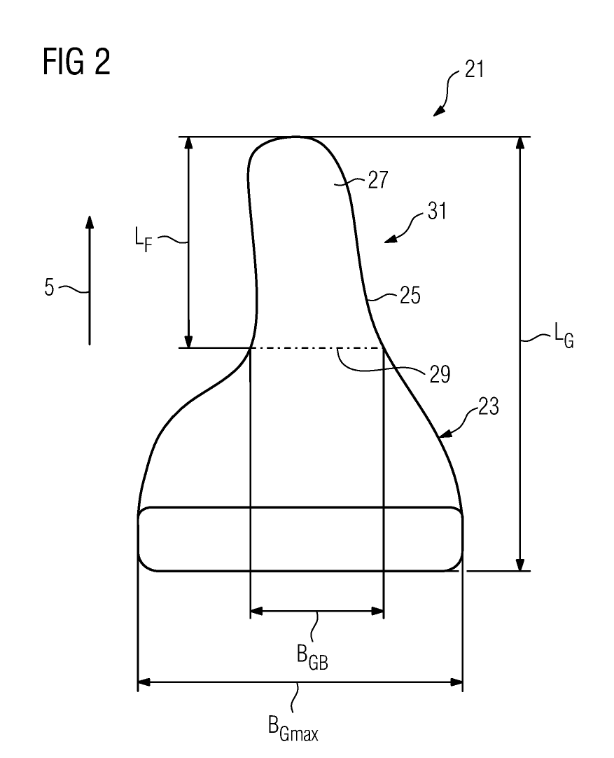

FIG. 2 shows, in contrast to the hearing device 1 of the prior art according to FIG. 1, an exemplary embodiment of an in-the-ear hearing device 21 according to the invention with a corresponding housing 23. The housing 23, which is produced in one piece from a plastic, comprises a housing main body 25 and a finger-shaped extension 27 for receiving an ear mold. Starting from a housing base 29 of the housing 23, the finger-shaped extension 27 extends, with no increase of its diameter, along the insertion direction 5 of the hearing device 21. Rather, starting from the housing base 29, the cross-sectional area of the finger-shaped extension 27 perpendicular to the insertion direction 5 tapers gradually to the point in insertion direction 5. In other words, the width B_{GB} of the housing base 29 is at the same time the maximum outer dimension of the extension 27.

The housing 23 has a total length L_{G} of 15 mm, for example, the length L_{F} of the finger-shaped extension 27 along the insertion direction 5 is 7.5 mm, for example, and is thus 50% of the corresponding total length L_{G} of the housing 23 in this direction. The maximum width B_{Gmax} of the housing 23 transverse to the insertion direction 5 is 7.6 mm for example, the width B_{GB} of the housing base 29 in this direction is approximately 3 mm for example. Thus, the width B_{SB} of the housing base 29 transverse to the insertion direction 5 is just under 40% of the corresponding maximum width B_{Gmax} of the housing 23 in this direction.

The housing 23 or the finger-shaped extension 27 of the housing 23 makes available a slender and long receiving area 31 as far as the housing base 29, which receiving area 31 allows a tailor-made ear mold, also suitable for small auditory canals, to be secured to the housing 23 of the hearing device 21.

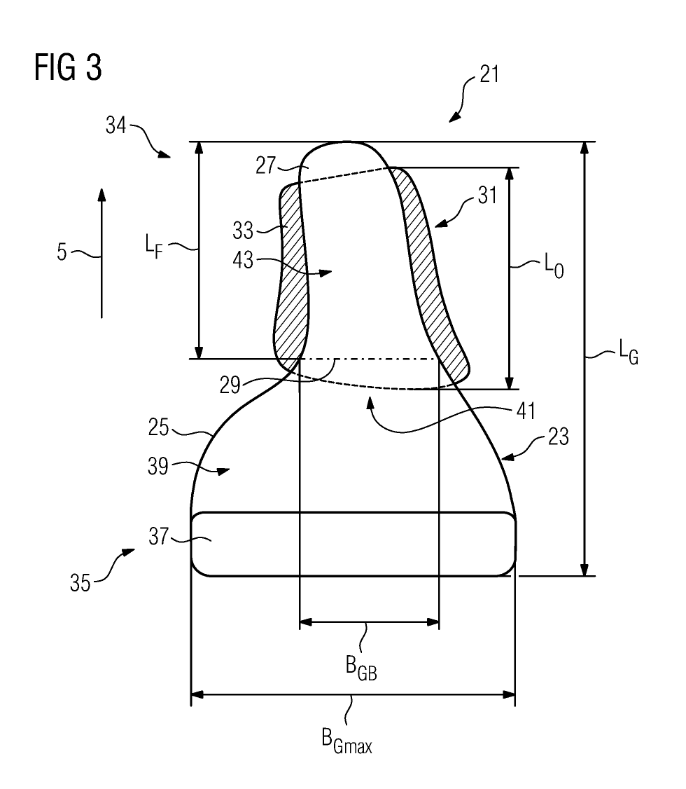

The housing 23 of the hearing device 21 is shown in FIG. 3 with an attached ear mold 33. The ear mold 33 is pushed onto the finger-shaped extension 27 from the side 34 of the housing 23 that protrudes into the auditory canal when the device is being worn. After it has been fitted, the ear mold 33 is secured with force-fit engagement on the finger-shaped extension 27 and is received with its total length L_{O} by the finger-shaped extension 27. In this way, a secure fit of the ear mold 33 is ensured and therefore also a comfortable fit of the hearing device 21.

Moreover, the housing 23 is closed with a housing lid 37 on the side 35 directed away from the finger-shaped extension 27. The components of the hearing device that are arranged in the housing are thus protected from dirt.

In the present case, the housing 23 accommodates a microphone 39, a signal processing unit 41 connected to the latter, and a loudspeaker 43 connected to the signal processing unit 41. The surrounding sound is captured by means of the microphone 39 and converted into an electrical signal. The electrical signal is amplified and further processed in the signal processing unit 41. The loudspeaker or also receiver 43 then generates acoustic output signals from the electrical signal, and the acoustic output signals are carried to the auditory system of the person wearing the hearing device and there generate the desired audio perception.

The following is a summary list of reference numerals and the corresponding structure used in the above description of the invention:
1 hearing device
3 housing
5 insertion direction
7 side
9 dome
10 securing portion
11 housing portion
13 line/housing base
21 hearing device
23 housing
25 housing main body
27 finger-shaped extension
29 housing base
31 receiving area
33 ear mold
34 side
35 side
37 housing lid
39 microphone
41 signal processing unit
43 loudspeaker
L_{G} total length of the housing
L_{GAD} length of the housing portion with dome
L_{GA} length of the housing portion without dome
L_{F} length of the finger-shaped extension
L_{O} length of the ear mold
B_{GB} width of the housing base
B_{Gmax} maximum width of the housing

1. A hearing device, comprising:
a housing having a housing main body and a finger-shaped extension for receiving an ear mold;
said housing having a total length in an insertion direction of the hearing device and a maximum width transverse to the insertion direction;
said finger-shaped extension, starting from a housing base, extending along the insertion direction of the hearing device;
said finger-shaped extension having a length along the insertion direction amounting to at least 50% of said total length of said housing;
said housing base having a width transverse to the insertion direction amounting to at most 40% of said maximum width of said housing; and
said finger-shaped extension having external dimensions along said length smaller than or equal to said width of said housing base.

2. The hearing device according to claim 1, wherein said total length of said housing lies in a range between 12 mm and 17 mm.

3. The hearing device according to claim 1, wherein a cross-sectional area of said finger-shaped extension, perpendicular to the insertion direction, tapers in the insertion direction, starting from said housing base.

4. The hearing device according to claim 1, wherein a cross-sectional area of said housing main body, perpendicular to the insertion direction, tapers in the insertion direction, as far as said housing base.

5. The hearing device according to claim 1, which comprises an ear mold disposed on said finger-shaped extension.

6. The hearing device according to claim 5, wherein said ear mold is secured with force-fit engagement on said finger-shaped extension.

7. The hearing device according to claim 5, wherein said ear mold is received on said finger-shaped extension with an entire length of said ear mold along the insertion direction.

8. The hearing device according to claim 1, which comprises a housing lid disposed to close said housing on a side thereof directed away from said finger-shaped extension.

9. The hearing device according to claim 1, which comprises a plurality of components accommodated in said housing, said components being selected from the group consisting of at least one microphone, a signal processing unit connected to said at least one microphone, and a loudspeaker connected to said signal processing unit.

10. The hearing device according to claim 1, wherein said housing is a housing of an in-the-ear hearing device.
